(19) United States
(12) Patent Application Publication
(10) Pub. No.: US 2008/0168522 A1
(43) Pub. Date: Jul. 10, 2008

(54) Broadcast communication converter system and method

(76) Inventor: Sang Ki Choi, Goyang-Si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/650,088

(22) Filed: Jan. 5, 2007

(51) Int. Cl. H04N 7/173

(52) U.S. Cl. 725/131

(57) ABSTRACT

The present invention relates to a system and method for receiving and transmitting publically available broadcast programs to a registered external Internet protocol (IP) address. The received broadcast programs are digitally encoded and stored before transmission. More specifically, a broadcast communication converter system includes a broadcast source for creating predetermined broadcast programs in order to provide the created broadcast programs through a public broadcast network, and a broadcast communication converter for receiving the broadcast programs, digitally encoding the broadcast programs to create broadcast communication contents, storing the created broadcast communication contents into a predetermined recording medium, and transmitting the broadcast communication contents to an external broadcast communication contents target through a wired/wireless communication network.

### BACKGROUND

Since analog broadcast of National Television System Committee (NTSC) color method commenced in 1954 in the United States, analog color broadcast has played an important role as the most familiar information source and amusement provider for people. The analog broadcast is accomplished in an analog transmission method through a public network that covers a certain area, for which an analog television (TV) receives the analog broadcast and displays the received analog broadcast through a cathode-ray tube.

Meanwhile, studies on TV for providing the biggest screen and the best screen quality thereon have been continued in a technical point of view, and digital broadcast has emerged in this process. That is, as the conventional analog TVs grow in size day after day, appliance manufacturers come to face several technical limits. It is difficult to implement a clear image on an extra-large TV screen over 40 inches with conventional broadcast and receiver specifications and a cathode-ray tube is inappropriate for home use since it is too voluminous, which are the reasons for the advent of a digital TV. In order to overcome such limits, a high definition TV (HDTV) development project has begun from the 1960s under the leadership of appliance manufacturers and broadcasting industries all over the world.

Advancement has been continued thereafter and studies on broadcasting and communications have been done focusing on digitalization in all countries of the world, including Korea. That is, the digital broadcast for digitally transmitting broadcast programs using digital compression techniques is being commercialized or will be commercialized in Korea, the United States, Europe and Asia through satellite broadcast, cable broadcast and terrestrial broadcast. The advantages of such digital broadcast competitively developed by advanced countries including Korea are multifold. That is, since HDTVs are superior to conventional analog TVs of NTSC in view of their image quality and sound quality, and can also provide a variety of communication services, they are considered as the most perfect product in the age of multimedia.

However, the analog broadcast and the digital broadcast have the following problems. First, in the case of the analog broadcast, there are restrictions in recording and reproducing analog broadcast programs. Conventionally, there is inconvenience in that analog broadcast programs should be recorded on a tape of a video tape recorder (VTR) to perform instant recording or reserved recording thereof, and a user should then reproduce the recorded broadcast programs later using a VTR and view the recorded broadcast programs only through an analog TV. Accordingly, there are inconveniences in that the recorded video tapes should be kept separately and both a VTR and an analog TV should be provided to reproduce the broadcast programs. Similarly, in the case of digital broadcast such as Digital Multimedia Broadcasting (DMB) broadcast, there is also inconvenience in that although digital broadcast programs are recorded and saved in the form of digital files, an additional computer provided with a monitor should be prepared to view the digital broadcast programs.

Second, there is a problem in that a method of providing the recorded broadcast programs to a third party who has the proper right to view the broadcast programs is not prepared. Even though every person can view analog broadcast programs for free owing to the publicness thereof, some people living in an area difficult to receive good broadcast signals cannot frequently view the analog broadcast programs. Therefore, there is another problem in that some people in an area receiving poor broadcast signals should subscribe to cable TV or additionally rent recorded video tapes to view the programs. As is the same in the terrestrial DMB broadcast among the digital broadcast, even though it should provide broadcast content for free owing to the publicness unlike the satellite DMB broadcast, people who live in an area not covered by a broadcasting base station cannot view the DMB broadcast programs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, the present invention is directed to a system and method for providing a display and audio device, wherein broadcast programs can be digitally converted, stored in an additional storage unit in the form of broadcast communication contents and then reproduced later. Further, the recorded file contents are transmitted to a third party who has the right to view the contents for free, so that the relevant third party can receive and view the broadcast communication contents for free.

According to an aspect of the present invention, there is provided a broadcast communication converter system, comprising a broadcast source for creating predetermined broadcast programs to provide the created broadcast programs through a public broadcast network; and a broadcast communication converter for receiving the broadcast programs, digitally encoding the broadcast programs to create broadcast communication contents, storing the created broadcast communication contents into a predetermined recording medium, and transmitting the broadcast communication contents to an external broadcast communication contents target through a wired/wireless communication network. Further, the broadcast communication converter may comprise a tuner for tuning in to a desired channel among broadcast programs received through a public broadcast network; an encoder for digitally encoding the received broadcast programs to create broadcast communication contents; a storage unit corresponding to a predetermined memory recording medium for storing the created broadcast communication contents therein; and a control unit for transmitting the broadcast communication contents to an external broadcast communication contents target with a registered IP address through a wired/wireless communication network.

According to another aspect of the present invention, there is provided a method of operating a broadcast communication converter, comprising a first step of receiving broadcast programs from a broadcast source including a terrestrial broadcasting station, a cable TV broadcasting station or the like, which provides broadcast services, and tuning in to a desired channel; a second step of storing broadcast communication contents created by digitally encoding the broadcast programs tuned in to the desired channel into a predetermined recording medium; and a third step of transmitting the stored broadcast communication contents to a certain IP address through a wired/wireless communication network.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram showing a broadcast communication converter system according to an embodiment of the present invention;

FIG. 2 is a block diagram showing the internal configuration of a broadcast communication converter; and

FIGS. 3 and 4 are flowcharts illustrating the operating procedures of the broadcast communication converter system.

### DETAILED DESCRIPTION

Hereinafter, a preferred embodiment of the present invention will be described in greater detail with reference to the accompanying drawings. It should be noted that when elements are designated by reference numerals throughout the drawings, like elements are designated by like reference numerals even though they are shown in different figures of the drawings. Further, if it is determined that specific descriptions on known related functions or constitutions may unnecessarily make the subject matter of the present invention obscure in the description of the present invention, detailed descriptions thereof will be omitted herein. In addition, the terms used hereinafter are terms defined in consideration of their functions in the present invention and may be changed according to general practices of those skilled in the art. The definitions should be made based on the overall disclosure herein.

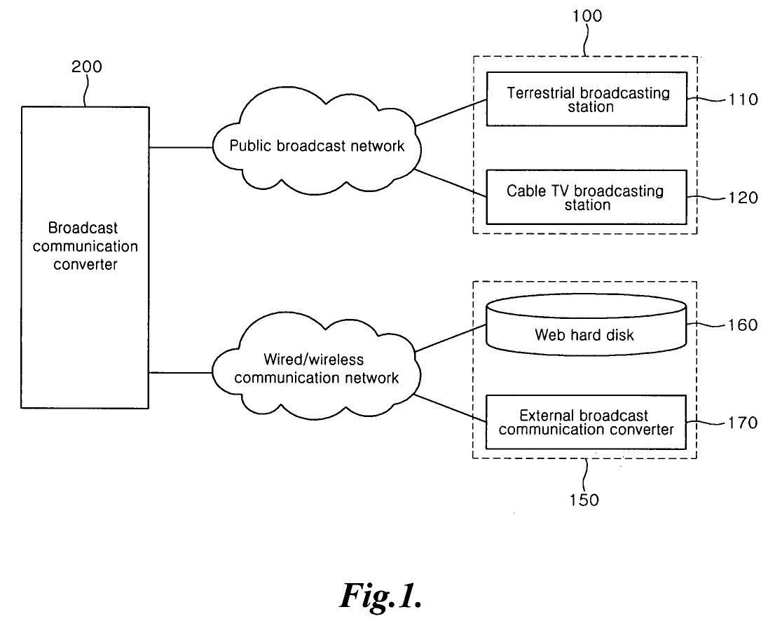

Referring to FIG. 1, a pictorial diagram depicts a view showing the configuration of a broadcast communication converter system according to an embodiment of the present invention.

The broadcast communication converter 200 receives broadcast programs from a broadcast source 100, converts the broadcast programs into digital data, stores the digital data in the form of certain broadcast communication contents, and then transmits the stored broadcast communication contents to a certain broadcast communication contents target 150. Accordingly, although the external broadcast communication contents target 150 does not receive broadcast contents directly from a public network, it can receive digitally converted and recorded broadcast communication contents through the broadcast communication converter 200.

The broadcast source 100 is a broadcasting station server for making and providing predetermined broadcast programs, such as a terrestrial broadcasting station 110 or a cable TV broadcasting station 120, which provides predetermined broadcast programs to the broadcast communication converter 200 through a public broadcast network. The terrestrial broadcasting station 110 is a base station for providing NTSC analog broadcasting services or digital broadcasting services such as a terrestrial DMB. There is no limitation so long as the terrestrial broadcasting station is a broadcasting base station capable of providing broadcasting services to the public without charging extra subscription fees.

The broadcast communication converter 200 reproduces broadcast programs provided by the broadcast source 100 in real time using reproduction means in the broadcast communication converter 200 or by an additional TV (not shown in FIG. 1) outside the converter. Further, the broadcast communication converter 200 digitally converts the broadcast programs provided by the broadcast source 100 in real time, stores the converted broadcast programs in the form of broadcast communication contents, and transmits the converted and stored broadcast communication contents to the broadcast communication contents target 150 (a Web hard disk or external broadcast communication converter). In order to transmit the broadcast communication contents to the broadcast communication contents target 150, the broadcast communication converter 200 registers and stores the unique IP address of a corresponding external device, and the broadcast communication contents stored in the broadcast communication converter are transmitted to the IP address registered and stored as such.

The broadcast communication contents target 150 receives predetermined broadcast communication contents from the broadcast communication converter and particularly refers to a device capable of receiving the broadcast communication contents through a wired/wireless communication network, such as a web hard disk 160 or an external broadcast communication converter 170. The Web hard disk 160 is a file storage means on the Web, which can receive and store the broadcast communication contents transmitted from the broadcast communication converter 200. Here, a user can download and reproduce the broadcast communication contents stored in the web hard disk 160 at any time. Similarly, the external broadcast communication converter 170 is a converter having the same structure as that of the broadcast communication converter 200 and is connected to the broadcast communication converter through a wired/wireless communication network. Accordingly, the external broadcast communication converter 170 converts, stores and reproduces the broadcast communication contents transmitted from the broadcast communication converter 200. Since each of the web hard disk 160 and the external broadcast communication converter 170 has a unique IP address, the broadcast communication converter 200 can recognize the web hard disk 160 or the external broadcast communication converter 170 using such an IP address.

Meanwhile, since the external broadcast communication converter 170 may be provided within a portable multimedia player (PMP), broadcast programs can be reproduced using the portable multimedia player provided with the broadcast communication converter even in an area where it is impossible to watch the broadcast programs.

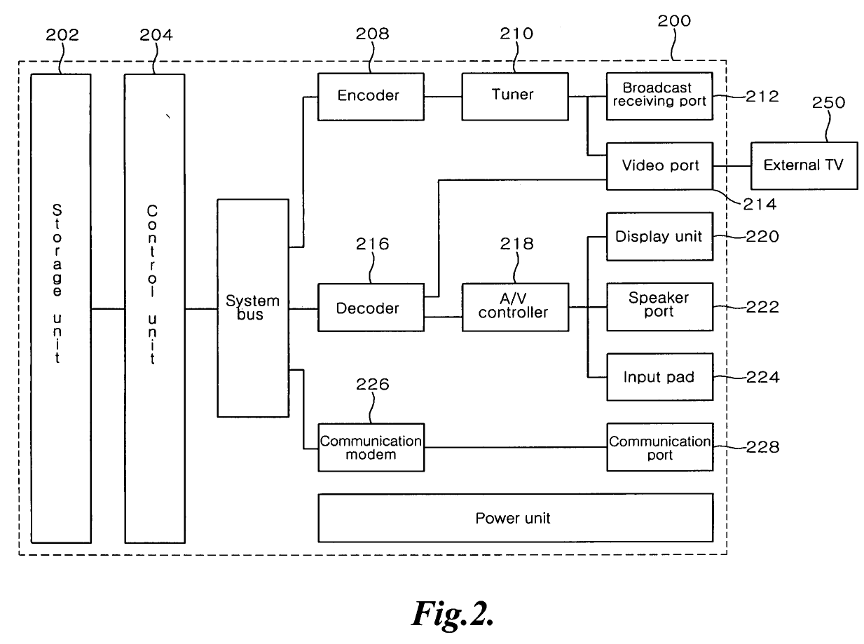

FIG. 2 is a block diagram showing the internal configuration of the broadcast communication converter according to an embodiment of the present invention. The broadcast communication converter 200 shown in FIG. 2 corresponds to an embodiment of a device that receives, records, and stores analog broadcast programs. Hereinafter, the broadcast communication converter for receiving and recording analog broadcast programs shown in FIG. 2 will be described. However, it is apparent that the present invention can also be applied to another embodiment of a broadcast communication converter capable of receiving, recording and storing digital broadcast programs.

The internal configuration of the broadcast communication converter shown in FIG. 2 will be described with reference to FIG. 1. If the terrestrial broadcasting station 110 (or the cable TV broadcasting station) creates and transmits broadcast programs through a public broadcast network, a broadcast receiving port 212 in the broadcast communication converter 200 receives the broadcast programs and transfers them to a tuner 210. The tuner 210 is a module having a function of tuning in to a selected broadcast channel. That is, the tuner performs a function of tuning in to a frequency of a channel selected by the user among the received broadcast channels. An encoder 208 performs the operation of digitally encoding the tuned analog broadcast programs. The digital encoding corresponds to a process of converting YUV analog broadcast programs into RGB digital broadcast programs. Such a conversion can be performed by a variety of conventionally known methods. An example of a YUV-to-RGB conversion is represented below in the following mathematical expression.

R=Y+0.956U+0.621V

G=Y+0.272U+0.647V

B=Y+1.1061U+1.703V

The digitally encoded broadcast programs created through digital conversion by the encoder are stored in a storage unit 202 in the form of broadcast communication contents through a system bus 206. The storage unit 202 is a module capable of inputting and/or outputting information, such as a hard disk, a flash memory, a compact flash card, a secure digital card, a smart media card, a multi-media card or a memory stick. The storage unit 202 may be provided within the broadcast communication converter or additionally as an external memory card.

A decoder 216 reads the broadcast communication contents stored in the storage unit 202 through the system bus 206 and decodes the broadcast communication contents into YUV analog format. Accordingly, the decoder 216 should be provided with a codec required for the above decoding operation. An A/V controller 218 divides recorded programs received from the decoder 216 into video and audio data, and outputs the video and audio data to a display unit 220 and a speaker 222, respectively, provided within the broadcast communication converter. Accordingly, since the recorded programs are self-reproduced through the display unit 220 and the speaker 222 within the broadcast communication converter 200, an additional reproduction device such as an external TV is not necessary.

Alternatively, the decoded programs can be reproduced through an additional external reproduction device such as the external TV 250 using a video port 214, rather than through its own display unit and speaker. Therefore, the video port 214 performs a function of transmitting the recorded programs to the external TV.

A communication modem 226 and a communication port 228 are used to transmit the broadcast communication contents stored in the storage unit to the external Web hard disk or broadcast communication converter. The communication modem supports a transmission protocol for communicating with a wired/wireless communication network, and the communication port provides layer interfaces of the wired/wireless communication network. Accordingly, the communication modem and the communication port can use either a wired communication method such as the Ethernet, universal serial bus, IEEE 1394, serial communication, parallel communication, or a wireless communication method such as Infrared Radiation, Bluetooth, Home Radio Frequency (RF) and wireless LAN.

Further, it is apparent that the communication modem 226 and the communication port 228 perform a function of receiving broadcast communication contents transmitted from the outside through a wired/wireless communication network. Therefore, in a case where the communication modem and the communication port have received the broadcast communication contents through the wired/wireless communication network, the received broadcast communication contents can be stored in the storage unit 202 through the system bus 206.

A power unit 230 performs a function of supplying electric power to respective component blocks in the broadcast communication converter. An input pad 224 is a user interface (UI) responsible for interface with a user. A control unit 204 controls the component blocks and the system bus to perform digital conversion, recording, storage, and transmission to the outside.

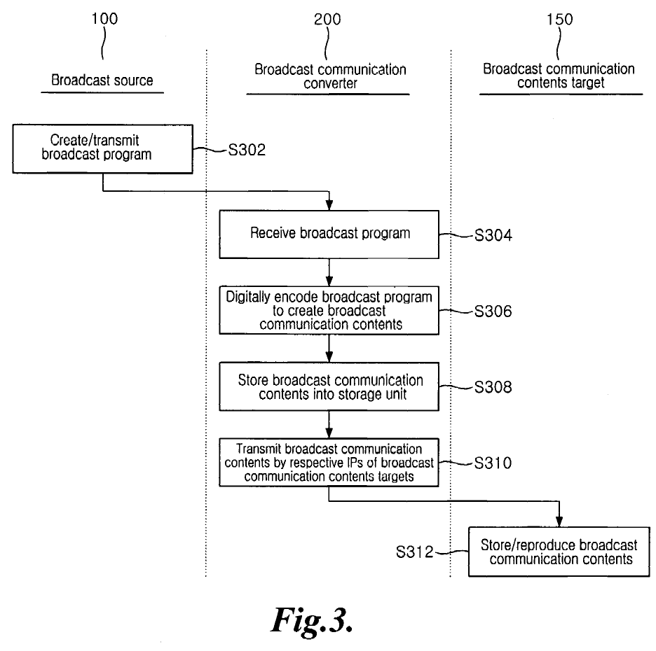

FIG. 3 is a flowchart illustrating a process of storing broadcast programs received from a terrestrial broadcasting station or a cable TV broadcasting station and transmitting the stored broadcast programs to an external web hard disk or an external broadcast communication converter according to the present invention.

If the broadcast source 100 such as the terrestrial broadcasting station or the cable TV broadcasting station creates broadcast programs and transmits the broadcast programs through a public network (step S302), the broadcast communication converter 200 receives the broadcast programs (step S304). Then, the converter is tuned to a desired channel, and the tuned broadcast programs are digitally encoded (step S306) and stored in the storage unit through the system bus (step S308). It has been described above that the broadcast programs created through the digital encoding are referred to as broadcast communication contents. Therefore, the files digitally encoded and stored in the storage unit will be hereinafter referred to as broadcast communication contents.

Furthermore, the control unit transmits the broadcast communication contents stored in the storage unit to the broadcast communication contents target 150 with a previously registered IP address (step S310). The broadcast communication contents target 150 is an object medium with an IP address capable of receiving the broadcast communication contents stored in the storage unit through a wired/wireless communication network. The broadcast communication contents target may be composed of a Web hard disk or an external broadcast communication converter. Therefore, according to the registered IP address, the broadcast communication contents carried on the wired/wireless communication network are stored in the Web hard disk or transmitted to the external broadcast communication converter, so that the contents can be reproduced at the external broadcast communication converter (step S312).

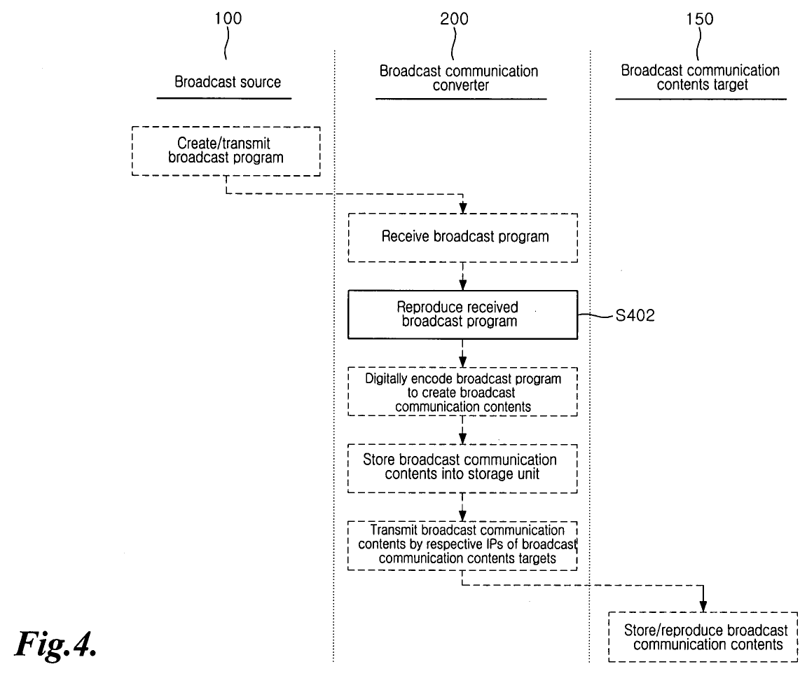

Meanwhile, FIG. 3 illustrates the process of allowing the broadcast communication converter to receive broadcast programs from the broadcast source and then to convert the broadcast programs through digital encoding, store the encoded broadcast programs and transmit the encoded broadcast programs to the external broadcast communication contents target without real-time reproduction. The broadcast communication converter can encode, store and transmit the broadcast programs received from the broadcast source to the outside, while reproducing the broadcast programs in real time. That is, as shown in FIG. 4, the broadcast communication converter can be driven through a process including an additional broadcast reproducing step (step S402) unlike a process shown in FIG. 3. The above broadcast reproduction can be performed at an external TV using the video port. Alternatively, the broadcast contents can be self-reproduced through the display unit and the speaker provided in the broadcast communication converter without using an external TV. Therefore, in a case where the broadcast contents are self-reproduced as described above, the broadcast contents stored in the storage unit will be decoded in the decoder and then reproduced through the display unit and the speaker via the A/V controller.

On the other hand, an external broadcast communication converter which has received predetermined broadcast communication contents from the broadcast communication converter can decode and reproduce the received broadcast communication contents while storing the received broadcast communication contents in its own recording medium. The above reproduction can be made at an external TV through the video port. It is also apparent that the reproduction can be made through the display unit and the speaker of the converter.

Although the present invention has been described and illustrated in connection with the specific preferred embodiment of a broadcast communication converter, it will be readily understood by those skilled in the art that various modifications and changes can be made thereto without departing from the spirit and scope of the present invention defined by the appended claims. Accordingly, the present invention should be construed as including the inventions defined by the appended claims and the equivalents thereof.

According to the present invention as described above, broadcast programs are reproduced in real time and automatically converted into broadcast communication contents, i.e., communication digital files, and then transmitted to registered IP addresses in real time. Thus, digital files can be reproduced without using a conventional analog video player. Therefore, there is an advantage in that the broadcast communication contents transmitted from the broadcast communication converter can be received, reproduced and stored in real time even at a distant place difficult to receive good broadcast signals. Accordingly, the problems, in that the broadcast programs can neither be stored due to inconvenient recording environments nor be secured due to poor broadcast signals even though a user has the right to view the broadcast programs for free, can be solved by receiving broadcast communication contents, i.e. digital files, from a broadcast communication converter at other locations. Consequently, the present invention can be an effective solution for a location that receives poor broadcast signals. Further, in the case of a mobile object, such as a vehicle, which has difficulty receiving an analog broadcast, a user can merely subscribe to wideband wireless communication services to enjoy real-time broadcast services for all channels in the same manner as when the user receives the broadcast at home through a cable. Therefore, there is another advantage in that the user can view more diverse broadcast programs in real time or can view the stored broadcast communication contents in a video-on-demand (VOD) method without need to subscribe an additional mobile broadcast service such as a DMB service.

The embodiments of the invention in which an exclusive property or privilege is claimed are defined as follows:

1. A broadcast communication converter, comprising:
a tuner for tuning in to a desired channel among broadcast programs received through a public broadcast network;
an encoder for digitally encoding the received broadcast programs to create broadcast communication contents;
a storage unit corresponding to a predetermined memory recording medium for storing the created broadcast communication contents therein; and
a control unit for transmitting the broadcast communication contents to an external broadcast communication contents target with a registered IP address through a wired/wireless communication network.

2. The broadcast communication converter as claimed in claim 1, further comprising:
a decoder for decoding the stored broadcast communication contents into analog contents using a predetermined codec to create decoded contents;
a display unit and a speaker for reproducing the decoded contents; and
an A/V controller for controlling an output of the decoded contents to the display unit and the speaker.

3. A broadcast communication converter system, comprising:
a broadcast source for creating predetermined broadcast programs to provide the created broadcast programs through a public broadcast network; and
a broadcast communication converter for receiving the broadcast programs, digitally encoding the broadcast programs to create broadcast communication contents, storing the created broadcast communication contents into a predetermined recording medium, and transmitting the broadcast communication contents to an external broadcast communication contents target through a wired/wireless communication network.

4. The broadcast communication converter system as claimed in claim 3, wherein the broadcast source is a broadcast providing server including a terrestrial analog/digital broadcasting station and a cable TV broadcasting station.

5. The broadcast communication converter system as claimed in claim 3, wherein the broadcast communication converter receives the broadcast programs, digitally encodes the broadcast programs, and simultaneously stores and reproduces the broadcast programs in real time.

6. The broadcast communication converter system as claimed in claim 5, wherein the broadcast programs are reproduced in real time through an external TV.

7. The broadcast communication converter system as claimed in claim 5, wherein the broadcast programs are self-reproduced in real time through a reproducing device provided within the broadcast communication converter.

8. The broadcast communication converter system as claimed in claim 3, wherein the broadcast communication contents target includes a Web hard disk capable of storing the broadcast communication contents therein and an external broadcast communication converter existing outside the broadcast communication converter.

9. The broadcast communication converter system as claimed in claim 8, wherein the external broadcast communication converter stores received broadcast communication contents into a predetermined recording medium and simultaneously decodes and reproduces the received broadcast communication contents in real time.

10. The broadcast communication converter system as claimed in claim 3, wherein the broadcast communication contents target is assigned a unique IP address.

11. The broadcast communication converter system as claimed in claim 3, wherein the broadcast communication converter comprises:
a tuner for tuning in to a desired channel among the broadcast programs received through a public broadcast network;
an encoder for digitally encoding the received broadcast programs and creating broadcast communication contents;
a storage unit corresponding to a predetermined memory recording medium for storing the created broadcast communication contents therein;
a control unit for transmitting the broadcast communication contents to the broadcast communication contents target with a registered IP address through a wired/wireless communication network; and
a communication port responsible for external communication interface with the broadcast communication contents target.

12. The broadcast communication converter system as claimed in claim 11, wherein the broadcast communication converter further comprises:
a decoder for decoding the stored broadcast communication contents into analog contents using a predetermined codec to create decoded contents;
a display unit and a speaker for reproducing the decoded contents; and
an A/V controller for controlling an output of the decoded contents to the display unit and the speaker.

13. A method of operating a broadcast communication converter, comprising:
a first step of receiving broadcast programs from a broadcast source including a terrestrial broadcasting station, a cable TV broadcasting station or the like, which provides broadcast services, and tuning in to a desired channel;
a second step of storing broadcast communication contents created by digitally encoding the broadcast programs tuned in to the desired channel into a predetermined recording medium; and
a third step of transmitting the stored broadcast communication contents to a certain IP address through a wired/wireless communication network.

14. The method as claimed in claim 13, further comprising the step of reproducing in real time the broadcast programs tuned in to a desired channel in the first step.

15. The method as claimed in claim 13, further comprising the step of decoding the broadcast communication contents stored in a predetermined recording medium in the second step and reproducing the decoded broadcast communication contents using a reproducing device provided within the relevant broadcast communication converter.

16. The method as claimed in claim 13, further comprising a fourth step of storing the broadcast communication contents transmitted in the third step into an external Web hard disk.

17. The method as claimed in claim 13, further comprising the step of transmitting the broadcast communication contents transmitted in the third step to a second broadcast communication converter and reproducing/storing the broadcast communication contents at the second broadcast communication converter.
